(19) United States
(12) Patent Application Publication
(10) Pub. No.: US 2026/0226205 A1
(43) Pub. Date: Aug. 6, 2026

(54) POLYVINYL ALCOHOL RESIN, WATER-SOLUBLE FILM, EXTRUSION-MOLDED ARTICLE, FILAMENT, NONWOVEN FABRIC, CONTAINER, METHOD FOR PRODUCING WATER-SOLUBLE FILM, AND AQUEOUS SOLUTION

(71) Applicant: Kuraray Co., Ltd., Okayama (JP)

(72) Inventors: Yoshiaki ASANUMA, Okayama (JP); Yosuke KUMAKI, Tokyo (JP); Michinari SEKI, Harbourfront Avenue (SG)

(73) Assignee: Kuraray Co., Ltd., Okayama (JP)

(21) Appl. No.: 19/152,424

(22) PCT Filed: Jan. 30, 2024
(86) PCT No.: PCT/JP2024/002956

§ 371 Date: Jul. 30, 2025

(30) Foreign Application Priority Data
Jan. 31, 2023 (JP) 2023-013392

(51) Int. Cl. C08F 8/12; B65D 65/46; C08J 5/18; D01F 6/34; D04H 1/4309

(52) U.S. Cl. CPC C08F 8/12; B65D 65/46; C08J 5/18; D01F 6/34; D04H 1/4309; C08F 2800/10; C08J 2329/04

(57) ABSTRACT

The present disclosure provides a polyvinyl alcohol resin including a modified polyvinyl alcohol comprising an N-vinylamide unit.

### TECHNICAL FIELD

The present invention relates to a polyvinyl alcohol resin, a water-soluble film, an extruded product, a filament, a non-woven fabric, a container, a method for producing a water-soluble film, and an aqueous solution.

### BACKGROUND ART

As a packaging mode of a variety of chemicals such as an agrochemical, a laundry detergent, a bleach, a toiletry product, an industrial chemical, etc., a packaging mode called unit packaging or the like is known, in which a certain amount of such a variety of chemicals is sealed in each package made of a water-soluble film. In the case of the unit packaging, the package can be used by being directly put into water, so that the packaging film as well as the content can be dissolved or dispersed in the water. The unit packaging is advantageous, for example, in that a hazardous chemical or the like can be used without direct touch, that packaging a certain amount of content eliminates the necessity of weighing at the time of use, and that it is unnecessary to dispose of, after use, a container for packaging a chemical.

The water-soluble film used for the unit packaging or the like is required to have favorable solubility in cold water, sufficient mechanical strength, favorable biodegradability, and the like. In such circumstances, water-soluble films containing a variety of modified polyvinyl alcohols (hereinafter, a polyvinyl alcohol may be referred to as “PVA”) have been developed. Patent Document 1 discloses a water-soluble film containing a modified polyvinyl alcohol which contains, in a molecule thereof, 1 to 10 mol % of an N-vinylamide unit and 0.020 to 4.0 mol % of a carboxy group and a lactone ring in total, and has a degree of polymerization of 300 to 3,000 and a degree of saponification of 75 to 99.5 mol %.

### PRIOR ART DOCUMENT

### Patent Document

Patent Document 1: Japanese Unexamined Patent Application, Publication No. 2003-

### SUMMARY OF THE INVENTION

### Problems to be Solved by the Invention

In general, such a water-soluble film is produced using a PVA aqueous solution as a film-forming stock solution. In the film formation using the PVA aqueous solution, to remove dirt, dust, foreign matters, and/or the like that have/has contaminated the solution, the PVA aqueous solution may be filtered before the film formation. If a filter is clogged during the filtration, the filtration rate (the rate at which a liquid passes through the filter) may decrease to lower the productivity, or filter replacement may cause an increase in cost. As for the modified PVA containing the N-vinylamide unit disclosed in Patent Document 1, the filterability in a state of an aqueous solution is not considered.

An object of the present invention is to provide: a polyvinyl alcohol resin which enables obtaining a water-soluble film having favorable cold-water solubility and mechanical strength, has favorable biodegradability, and is superior in filterability in a state of an aqueous solution; a water-soluble film, an extruded product, a filament, a non-woven fabric, and a container each containing such a polyvinyl alcohol resin; a method for producing a water-soluble film; and an aqueous solution.

### Means for Solving the Problems

The foregoing problems can be solved by providing any of the followings:
(1) a polyvinyl alcohol resin containing, as a principal component, a modified polyvinyl alcohol containing an N-vinylamide unit, wherein a ratio (N1/N2) of the number (N1) of 1-μm-size particles to the number (N2) of 2-μm-size particles contained in 1 mL of a 2% by mass aqueous solution of the polyvinyl alcohol resin is 0.1 or more and 50 or less;
(2) the polyvinyl alcohol resin according to (1), wherein the modified polyvinyl alcohol has a content of the N-vinylamide unit of 0.3 mol % or more and 10 mol % or less, a degree of saponification of 70 mol % or more and 99.9 mol % or less, and an average degree of polymerization of 200 or more and 4,500 or less;
(3) the polyvinyl alcohol resin according to (1) or (2), wherein a total volume of the 1-μm-size particles and the 2-μm-size particles contained in 1 mL of the 2% by mass aqueous solution of the polyvinyl alcohol resin is 1 μm³ or more and 10,000 μm³ or less;
(4) the polyvinyl alcohol resin according to any one of (1) to (3), having a biodegradation rate of 60% or more;
(5) the polyvinyl alcohol resin according to any one of (1) to (4), wherein when a cast film obtained from the polyvinyl alcohol resin and having an average thickness of 50 μm is subjected to moisture conditioning at 20° C. and 65% RH for 1 week and then to an aqueous dissolution test at 5° C., a period of time of the dissolution is 5 sec or more and 3,000 sec or less;
(6) the polyvinyl alcohol resin according to any one of (1) to (5), further containing a polymerization inhibitor;
(7) a water-soluble film containing the polyvinyl alcohol resin according to any one of (1) to (6);
(8) the water-soluble film according to (7), formed from the polyvinyl alcohol resin in accordance with at least one process selected from the group consisting of a solvent casting process, a calender process, a blow molding process, an extrusion process, and a blow extrusion process;
(9) an extruded product obtained by extruding the polyvinyl alcohol resin according to any one of (1) to (6), the extruded product having a film shape or a filament shape;
(10) a filament containing the polyvinyl alcohol resin according to any one of (1) to (6);
(11) a non-woven fabric including the filament according to (10);
(12) a container including the water-soluble film according to (7) as a packaging material;
(13) the container according to (12), configured to be charged with at least one selected from the group consisting of an agrochemical, an oxidant, and a detergent;
(14) a method for producing a water-soluble film, the method including: preparing an aqueous solution containing the polyvinyl alcohol resin according to any one of (1) to (6); and forming a film by using the aqueous solution;
(15) the method for producing a water-soluble film according to (14), the method further including: before the forming, filtering the aqueous solution with a filter;
(16) an aqueous solution containing the polyvinyl alcohol resin according to any one of (1) to (6), wherein a content of the polyvinyl alcohol resin is 0.1 ppm or more and 50 ppm or less;
(17) the aqueous solution according to (16), having a temperature of 20° C. or more and 25° C. or less;
(18) the aqueous solution according to (16) or (17), further containing at least one of a magnesium ion or a calcium ion, wherein a total content of the magnesium ion and the calcium ion is 10 ppm or more and 400 ppm or less; and
(19) an aqueous solution containing the polyvinyl alcohol resin according to any one of (1) to (6), wherein a content of the polyvinyl alcohol resin is 3% by mass or more and 12% by mass or less.

### Effects of the Invention

According to the present invention, a polyvinyl alcohol resin which enables obtaining a water-soluble film having favorable cold-water solubility and mechanical strength, has favorable biodegradability, and is superior in filterability in a state of an aqueous solution; a water-soluble film, an extruded product, a filament, a non-woven fabric, and a container each containing such a polyvinyl alcohol resin; a method for producing a water-soluble film; and an aqueous solution can be provided.

### DESCRIPTION OF EMBODIMENTS

Hereinafter, embodiments of the present invention will be described in detail. It is to be noted that the present invention is not limited to the following embodiments. It is to be noted that in the present specification, an upper limit value and a lower limit value of a numerical range (a content of each component, a value calculated from each component, physical properties, etc.) can be appropriately combined. Furthermore, a numerical range expressed with “to” means that the upper limit value and the lower limit value are included therein. That is to say, “A to B” means “A or more and B or less.”

### Polyvinyl Alcohol Resin

A polyvinyl alcohol (PVA) resin according to one embodiment of the present invention is a PVA resin containing, as a principal component, a modified PVA containing an N-vinylamide unit, wherein a ratio (N1/N2) of the number (N1) of 1-μm-size particles to the number (N2) of 2-μm-size particles contained in 1 mL of a 2% by mass aqueous solution of the PVA resin is 0.1 or more and 50 or less.

Since containing, as the principal component, the modified PVA containing the N-vinylamide unit, the PVA resin enables obtaining a water-soluble film having favorable cold-water solubility and mechanical strength and has favorable biodegradability. Furthermore, owing to the feature that the ratio (N1/N2) of the number (N1) of 1-μm-size particles to the number (N2) of 2-μm-size particles contained in 1 mL of the 2% by mass aqueous solution of the PVA resin is 0.1 or more and 50 or less, the PVA resin is superior in filterability in a state of an aqueous solution. Although the reasons for such effects are not certain, the following reasons can be presumed. It is generally considered that when a PVA aqueous solution is filtered with a filter having a predetermined pore size (for example, 1 μm), firstly, the pores are partly blocked by particles having a sufficiently large size with respect to the pore size, and then, the remaining spaces are completely blocked by smaller particles, and thus the filter is clogged. In the PVA resin of the present invention, when the ratio (N1/N2) of the number (N1) of 1-μm-size particles, which are relatively small particles, to the number (N2) of 2-μm-size particles, which are relatively large particles, is 50 or less, the spaces can be prevented from being completely blocked by the 1-μm-size particles, which are relatively small particles. It is to be noted that when the ratio (N1/N2) is as small as 50 or less, the filter clogging can be inhibited even in a case in which both the number (N1) of 1-μm-size particles and the number (N2) of 2-μm-size particles are large. In this regard, in the case in which the number (N2) of 2-μm-size particles is large, voids between these particles are likely to be formed due to, for example, deposition of the 2-μm-size particles on the filter surface. The higher likelihood of the formation of the voids is considered to influence the inhibition of the filter clogging. That is to say, it is considered that some of the 1-μm-size particles are consumed to fill such voids between the 2-μm-size particles, and thus, the spaces in the pores of the filter are prevented from being completely blocked by the 1-μm-size particles. For the foregoing reasons, it is presumed that the PVA resin enables inhibiting the filter clogging during the filtration of the aqueous solution and exerts superior filterability.

According to the invention disclosed in the present specification, a PVA resin which enables obtaining a water-soluble film having favorable cold-water solubility and mechanical strength, has favorable biodegradability, and is, in a state of an aqueous solution, superior in filterability with respect to a filter having a predetermined pore size (for example, a filter having a pore size of 0.5 μm or more and 2 μm or less, typically a pore size of 1 μm); a water-soluble film containing such a PVA resin; a method for producing a water-soluble film; and an aqueous solution may be provided.

It is to be noted that the “principal component” refers to a component having a highest content on a mass basis. The PVA resin may contain an optional component aside from the modified PVA, which is the principal component. Hereinafter, the PVA resin will be described in detail.

### Modified PVA

The modified PVA is a polymer containing a vinyl alcohol unit. The lower limit of a content of the vinyl alcohol unit with respect to all structural units in the modified PVA is, for example, preferably 60 mol %, more preferably 70 mol %, still more preferably 75 mol %, and even more preferably 80 mol %. On the other hand, the upper limit of the content of the vinyl alcohol unit is, for example, preferably 99.9 mol %, more preferably 99 mol %, and still more preferably 95 mol %.

The modified PVA contains the N-vinylamide unit. The N-vinylamide unit is a structural unit derived from an N-vinylamide compound (hereinafter, may be referred to as “N-vinylamide monomer”). Examples of the N-vinylamide monomer (a monomer giving an N-vinylamide unit) include a monomer represented by the following formula (I), N-vinyl-2-pyrrolidones, N-vinylcaprolactams, and the like.

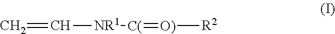

In the formula (I), R¹ represents a hydrogen atom or an alkyl group having 1 to 3 carbon atoms; and R² represents a hydrogen atom or an alkyl group having 1 to 5 carbon atoms.

Examples of the alkyl group having 1 to 3 carbon atoms and represented by R¹ include a methyl group, an ethyl group, a propyl group, an isopropyl group, and the like. Examples of the alkyl group having 1 to 5 carbon atoms and represented by R² include a methyl group, an ethyl group, a propyl group, an isopropyl group, a butyl group, an isobutyl group, a t-butyl group, a pentyl group, an isopentyl group, and the like.

Examples of the monomer represented by the above formula (I) include N-vinyl formamide, N-methyl-N-vinyl formamide, N-vinylacetamide, N-methyl-N-vinylacetamide, and the like. The monomer represented by the above formula (I) is preferably N-vinylacetamide.

In each of the N-vinyl-2-pyrrolidones, any one or two or more hydrogen atoms on a pyrrolidone ring may be substituted with an organic group, preferably an alkyl group, and still more preferably an alkyl group having 1 to 8 carbon atoms, and examples of the N-vinyl-2-pyrrolidones include N-vinyl-2-pyrrolidone, N-vinyl-3-propyl-2-pyrrolidone, N-vinyl-5,5-dimethyl-2-pyrrolidone, N-vinyl-3,5-dimethyl-2-pyrrolidone, N-vinyl-5-methyl-2-pyrrolidone, and the like. Of the N-vinyl-2-pyrrolidones, N-vinyl-2-pyrrolidone is preferred.

In each of the N-vinylcaprolactams, any one or two or more hydrogen atoms on a caprolactam ring may be substituted with an organic group, preferably an alkyl group, and still more preferably an alkyl group having 1 to 8 carbon atoms, and examples of the N-vinylcaprolactams include N-vinylcaprolactam, N-vinyl-4-methylcaprolactam, N-vinyl-6-methylcaprolactam, N-vinyl-6-propylcaprolactam, N-vinyl-7-butylcaprolactam, and the like. Of the N-vinylcaprolactams, N-vinylcaprolactam is preferred.

Of the N-vinylamide monomers, the N-vinyl-2-pyrrolidones or the N-vinylcaprolactams are preferred, and the N-vinyl-2-pyrrolidones are more preferred. Furthermore, N-vinylacetamide, N-vinyl-2-pyrrolidone, or N-vinylcaprolactam is also preferred, N-vinyl-2-pyrrolidone or N-vinylcaprolactam is more preferred, and N-vinyl-2-pyrrolidone is particularly preferred. By using such an N-vinylamide monomer, the cold-water solubility, the mechanical strength, the biodegradability, and the like of a water-soluble film to be obtained can be further improved. For example, in the case of using N-vinyl-2-pyrrolidone, the cold-water solubility, the biodegradability, and the like tend to become particularly favorable. Furthermore, in the case of using N-vinylcaprolactam, the mechanical strength tends to become particularly favorable.

Furthermore, for example, N-vinylcaprolactam (boiling point: approximately 267° C.) has a relatively high boiling point and may not be sufficiently removed when it remains in an unreacted state. In light of this point, N-vinyl-2-pyrrolidones having a relatively low boiling point (typically, N-vinyl-2-pyrrolidone (boiling point: approximately 148° C./13.3 kPa) are preferred. Furthermore, in light of this point, the N-vinylamide monomer is preferably a compound having a boiling point at 13.3 kPa of 200° C. or less, and more preferably a compound having a boiling point at 13.3 kPa of 160° C. or less. The lower limit of the boiling point at 13.3 kPa of the N-vinylamide monomer may be, for example, 80° C., 100° C., or 120° C.

A content (modification rate) of the N-vinylamide unit in the modified PVA is preferably 0.3 mol % or more and 10 mol % or less, more preferably 0.5 mol % or more and 5 mol % or less, still more preferably 0.7 mol % or more and 3.9 mol % or less, and even more preferably 1.0 mol % or more and 3.2 mol % or less. When the content of the N-vinylamide unit in the modified PVA falls within the above range, the cold-water solubility, the mechanical strength, the biodegradability, and the like of the water-soluble film to be obtained can be further improved. For example, in the case in which the content of the N-vinylamide unit in the modified PVA is greater than or equal to the lower limit, the cold-water solubility and the like tend to be improved. On the other hand, in the case in which the content of the N-vinylamide unit in the modified PVA is less than or equal to the upper limit, the biodegradability and the like tend to be improved. It is to be noted that the content of the N-vinylamide unit in the modified PVA is a content of the N-vinylamide unit with respect to all structural units in the modified PVA.

A degree of saponification of the modified PVA is preferably 70 mol % or more and 99.9 mol % or less, more preferably 75 mol % or more and 99.5 mol % or less, still more preferably 81.5 mol % or more and 97.5 mol % or less, and even more preferably 83.5 mol % or more and 96.0 mol % or less. When the degree of saponification of the modified PVA falls within the above range, the cold-water solubility, the mechanical strength, the biodegradability, and the like of the water-soluble film to be obtained can be further improved. For example, in the case in which the degree of saponification of the modified PVA is greater than or equal to the lower limit, the mechanical strength, the biodegradability, and the like tend to be improved. On the other hand, in the case in which the degree of saponification of the modified PVA is less than or equal to the upper limit, the cold-water solubility and the like tend to be improved. The degree of saponification of the modified PVA is a value measured in accordance with the method disclosed in JIS-K6726-1994.

An average degree of polymerization of the modified PVA is preferably 200 or more and 4,500 or less, more preferably 550 or more and 4,200 or less, still more preferably 700 or more and 4,000 or less, and even more preferably 1,100 or more and 3,500 or less. When the average degree of polymerization of the modified PVA falls within the above range, the cold-water solubility, the mechanical strength, the biodegradability, and the like of the water-soluble film to be obtained can be further improved. For example, in the case in which the average degree of polymerization of the modified PVA is greater than or equal to the lower limit, the mechanical strength and the like tend to be improved. On the other hand, in the case in which the average degree of polymerization of the modified PVA is less than or equal to the upper limit, the cold-water solubility, the biodegradability, and the like tend to be improved. The average degree of polymerization of the modified PVA is a viscosity-average degree of polymerization measured in accordance with the method disclosed in JIS-K6726-1994.

The modified PVA may contain a structural unit aside from the vinyl alcohol unit, the vinyl ester unit, and the N-vinylamide unit. It is to be noted that the lower limit of a total content of the vinyl alcohol unit, the vinyl ester unit, and the N-vinylamide unit with respect to all structural units contained in the modified PVA is preferably 90 mol %, more preferably 95 mol %, and may be still more preferably 99 mol % or 99.9 mol %. In the case in which the modified PVA consists substantially of the vinyl alcohol unit, the vinyl ester unit, and the N-vinylamide unit, the effects of the present invention are more sufficiently exhibited. The lower limit of a content of the modified PVA in the PVA resin is preferably 50% by mass, more preferably 70% by mass, still more preferably 80% by mass, and may be even more preferably 90% by mass, 95% by mass, 99% by mass, or 99.9% by mass. On the other hand, the upper limit of this content may be 100% by mass or may be 99.9% by mass, 99% by mass, 95% by mass, or 90% by mass.

### Number of Particles Etc. in Aqueous Solution

The ratio (N1/N2) of the number (N1) of 1-μm-size particles to the number (N2) of 2-μm-size particles contained in 1 mL of the 2% by mass aqueous solution of the PVA resin is 0.1 or more and 50 or less. The upper limit of the ratio (N1/N2) is preferably 40, more preferably 30, still more preferably 20, and even more preferably 10. When the ratio (N1/N2) is less than or equal to the upper limit, the filterability of the PVA resin in a state of an aqueous solution can be improved. On the other hand, the lower limit of the ratio (N1/N2) may be 0.2, 0.5, or 1.0.

The ratio (N1/N2) of the number (N1) of 1-μm-size particles to the number (N2) of 2-μm-size particles contained in 1 mL of the 2% by mass aqueous solution of the PVA resin is defined as a value measured by the following procedure.

Into a 110 mL sample tube equipped with a magnetic stirrer, deionized water and the PVA resin are added such that the concentration (content) of the PVA resin is 2% by mass. Next, the resulting mixture is heated using a steam bath, and after the liquid temperature reaches 95° C., stirring is performed for 2 hrs to dissolve the PVA resin. After that, the sample tube is immersed in a water bath at 20° C., stirring is performed for 30 min, and cooling is performed until the liquid temperature reaches 20° C. The 2% by mass aqueous PVA resin solution having a liquid temperature of 20° C. is subjected to the following measurement.

In the measurement, a particle counting device (a liquid particle counter “LiQuilaz S05” and a syringe sampling system “LS-200” connected to each other, both manufactured by Particle Measuring Systems) is used. It is to be noted that another device may be used as long as a similar measurement is possible. As particle size channels, a channel having a size of 1.00 μm or more and less than 1.41 μm is set to correspond to the 1-μm-size particles, and a channel having a size of 2.00 μm or more and less than 2.82 μm is set to correspond to the 2-μm-size particles. That is to say, in the present invention, the 1-μm-size particles are particles having a particle size of 1.00 μm or more and less than 1.41 μm, and the 2-μm-size particles are particles having a particle size of 2.00 μm or more and less than 2.82 μm. The measurement is performed with a sample flow rate being 20 mL/min and a sample volume being 5 mL and repeated 5 times. With regard to the number of particles detected in the channel having a size of 1.00 μm or more and less than 1.41 μm, an average value (number of particles per 5 mL) of three measurements in total excluding the first and second measurements is divided by 5 (mL) to obtain a value defined as NI (the number of 1-μm-size particles contained in 1 mL of the 2% by mass aqueous solution of the PVA resin). Furthermore, with regard to the number of particles detected in the channel having a size of 2.00 μm or more and less than 2.82 μm, an average value (number of particles per 5 mL) of three measurements in total excluding the first and second measurements is divided by 5 (mL) to obtain a value defined as N2 (the number of 2-μm-size particles contained in 1 mL of the 2% by mass aqueous solution of the PVA resin).

The ratio (N1/N2) can be adjusted by the production conditions. Specifically, for example, in a method for producing a modified PVA described later, after copolymerization of a vinyl ester monomer and an N-vinylamide monomer, a polymerization inhibitor is added to stop the polymerization reaction, the remaining N-vinylamide monomer and the like are removed under reduced pressure, and then saponification is performed to obtain a modified PVA. In this manner, a PVA resin having the ratio (N1/N2) of 0.1 or more and 50 or less can be effectively obtained. Although the reasons for this are not certain, the following consideration can be made: when unreacted vinyl acetate (a vinyl ester compound) is removed by a decompression process or the like after the completion of the polymerization reaction, the N-vinylamide monomer, which has a higher boiling point than the vinyl acetate, is condensed; in this state, a remaining radical initiator allows the polymerization reaction to proceed, so that a polymer having a high content of the N-vinylamide monomer unit is generated, and this polymer reacts with an alkali catalyst or the like used in the saponification reaction, so that the 1-μm-size particles increase. Therefore, by adding the polymerization inhibitor to stop the polymerization reaction and by performing saponification after removing the remaining N-vinylamide monomer and the like as much as possible, generation of the 1-μm-size particles is inhibited, and the ratio (N1/N2) tends to decrease. It is to be noted that even when the above production conditions are employed, in a case in which the content of the N-vinylamide unit is high or in a case in which the degree of saponification is high, the number (N1) of 1-μm-size particles and the number (N2) of 2-μm-size particles tend to become relatively large. Furthermore, in a case in which the remaining N-vinylamide monomer and the like are removed at a relatively high temperature, there is a tendency that the number (N1) of 1-μm-size particles decreases, whereas the number (N2) of 2-μm-size particles becomes relatively large.

The 1-μm-size particles and the 2-μm-size particles contained in 1 mL of the 2% by mass aqueous solution of the PVA resin are considered to be, but not limited to, insoluble matters of the modified PVA. Each of the particles may contain a product of a reaction between the modified PVA and another component, a component other than the modified PVA, or the like.

The number (N1) of 1-μm-size particles contained in 1 mL of the 2% by mass aqueous solution of the PVA resin is not particularly limited and is preferably 10 or more and 10,000 or less, more preferably 30 or more and 5,000 or less, still more preferably 50 or more and 3,000 or less, and even more preferably 70 or more and 2,000 or less, 90 or more and 1,000 or less, or 110 or more and 500 or less. The number (N2) of 2-μm-size particles contained in 1 mL of the 2% by mass aqueous solution of the PVA resin is preferably 10 or more and 10,000 or less, preferably 10 or more and 1,000 or less, more preferably 20 or more and 500 or less, still more preferably 30 or more and 300 or less, and even more preferably 40 or more and 200 or less.

A total volume of the 1-μm-size particles and the 2-μm-size particles contained in 1 mL of the 2% by mass aqueous solution of the PVA resin is preferably 1 μm³ or more and 10,000 μm³ or less, more preferably 10 μm³ or more and 5,000 μm³ or less, still more preferably 30 μm³ or more and 3,000 μm³ or less, and even more preferably 100 μm³ or more and 2,000 μm³ or less. When the total volume of the 1-μm-size particles and the 2-μm-size particles falls within the above range, for example, the filterability of the PVA resin in a state of an aqueous solution can be improved.

The total volume of the 1-μm-size particles and the 2-μm-size particles contained in 1 mL of the 2% by mass aqueous solution of the PVA resin is defined as a value determined in the following manner.

Assuming that the 1-μm-size particles and the 2-μm-size particles contained in 1 mL of the 2% by mass aqueous solution of the PVA resin and detected by the above-described procedure for determining the ratio (N1/N2) are each a perfect sphere, the diameter of each of the 1-μm-size particles detected in the channel having a size of 1.00 μm or more and less than 1.41 μm is set to 1.20 μm, and the diameter of each of the 2-μm-size particles detected in the channel having a size of 2.00 μm or more and less than 2.82 μm is set to 2.41 μm. From the values of N1 and N2 detected, the total volume is determined in accordance with the following equation.

$$Total volume ( {μm}^{3} ) = \frac{4 \times 3.14 \times ( {( 1.2 / 2 )}^{3} N 1 + {( 2.41 / 2 )}^{3} N 2 )}{3}$$

### Method for Producing Modified PVA

The modified PVA can be produced, for example, in such a manner that a vinyl ester monomer and an N-vinylamide monomer are copolymerized, and a vinyl ester copolymer obtained is saponified in an alcohol solution by using an alkali catalyst or an acid catalyst. By adjusting these production conditions (for example, conditions for the copolymerization reaction, the amount of the N-vinylamide monomer used, conditions for the saponification reaction, etc.), the average degree of polymerization, the modification rate (the content of the N-vinylamide unit), the degree of saponification, and the like of the modified PVA to be obtained can be controlled.

Examples of the vinyl ester monomer include vinyl formate, vinyl acetate, vinyl propionate, vinyl valerate, vinyl caprate, vinyl laurate, vinyl stearate, vinyl benzoate, vinyl pivalate, vinyl versatate, and the like. Of these, vinyl acetate is preferred.

Examples of a process for copolymerizing the vinyl ester monomer and the N-vinylamide monomer include known processes such as a bulk polymerization process, a solution polymerization process, a suspension polymerization process, an emulsion polymerization process, and the like. Of these processes, a bulk polymerization process, which is performed in the absence of a solvent, or a solution polymerization process, which is performed using a solvent such as an alcohol or the like, is preferred, and a solution polymerization process in which polymerization is performed in the presence of a lower alcohol is more preferred. The lower alcohol is preferably an alcohol having 3 or less carbon atoms, more preferably methanol, ethanol, n-propanol, or isopropanol, and still more preferably methanol. In the polymerization reaction by a bulk polymerization process or a solution polymerization process, either a batch method or a continuous method may be employed as a reaction method.

Examples of an initiator used in the polymerization reaction include known initiators such as: azo initiators such as 2,2′-azobis(isobutyronitrile), 2,2′-azobis(2,4-dimethylvaleronitrile), and 2,2′-azobis(4-methoxy-2,4-dimethylvaleronitrile); organic peroxide initiators such as benzoyl peroxide and n-propyl peroxycarbonate; and the like. The polymerization temperature in the polymerization reaction is not particularly limited and preferably falls within a range of 5° C. or more and 200° C. or less, and more preferably within a range of 30° C. or more and 100° C. or less. In the case in which methanol is used as a solvent, polymerization is preferably performed at a temperature close to the boiling point thereof.

When the vinyl ester monomer and the N-vinylamide monomer are copolymerized, a copolymerizable monomer may be further copolymerized within a range not leading to impairment of the effects of the present invention. Examples of such a monomer include: α-olefines such as ethylene, propylene, 1-butene, isobutene, and 1-hexene; acrylamide derivatives such as N-methylacrylamide and N-ethylacrylamide; methacrylamide derivatives such as N-methylmethacrylamide and N-ethylmethacrylamide; vinyl ether such as methyl vinyl ether, ethyl vinyl ether, n-propyl vinyl ether, isopropyl vinyl ether, and n-butyl vinyl ether; hydroxy group-containing vinyl ether such as ethylene glycol vinyl ether, 1,3-propanediol vinyl ether, and 1,4-butanediol vinyl ether; allyl acetate; allyl ether such as propyl allyl ether, butyl allyl ether, and hexyl allyl ether; oxyalkylene group-containing monomers; isopropenyl acetate; hydroxy group-containing α-olefines such as 3-buten-1-ol, 4-penten-1-ol, 5-hexen-1-ol, 7-octen-1-ol, 9-decen-1-ol, and 3-methyl-3-buten-1-ol; silyl group-containing monomers such as vinyltrimethoxysilane, vinylmethyldimethoxysilane, vinyldimethylmethoxysilane, vinyltriethoxysilane, vinylmethyldiethoxysilane, vinyldimethylethoxysilane, 3-(meth)acrylamide propyltrimethoxysilane, and 3-(meth)acrylamide propyltriethoxysilane; unsaturated carboxylic acid compounds such as maleic acid, fumaric acid, itaconic acid, acrylic acid, and methacrylic acid, and salt compounds thereof; unsaturated carboxylic acid ester compounds such as monomethyl maleate, dimethyl maleate, methyl acrylate, and methyl methacrylate; unsaturated carboxylic anhydride compounds such as maleic anhydride and itaconic anhydride; and the like. The upper limit of an amount of such a monomer used is, for example, preferably 20 mol %, more preferably 10 mol %, and may be 5 mol %, 3 mol %, 1 mol %, or 0.1 mol % with respect to all monomers used in the copolymerization.

As described above, the copolymerization reaction between the vinyl ester monomer and the N-vinylamide monomer is preferably stopped by addition of the polymerization inhibitor. Examples of the polymerization inhibitor include: a compound which inhibits the polymerization reaction by stabilizing a radical, has a molecular weight of 1,000 or less, and includes a conjugated double bond; and an aromatic compound; of these, an aromatic compound, especially a compound containing a phenolic hydroxyl group, is particularly preferred.

Specific examples of the compound which includes a conjugated double bond and may be used as the polymerization inhibitor include: conjugated dienes having a conjugated structure including two carbon-carbon double bonds, such as isoprene, 2,3-dimethyl-1,3-butadiene, 2,3-diethyl-1,3-butadiene, 2-t-butyl-1,3-butadiene, 1,3-pentadiene, 2,3-dimethyl-1,3-pentadiene, 2,4-dimethyl-1,3-pentadiene, 3,4-dimethyl-1,3-pentadiene, 3-ethyl-1,3-pentadiene, 2-methyl-1,3-pentadiene, 3-methyl-1,3-pentadiene, 4-methyl-1,3-pentadiene, 1,3-hexadiene, 2,4-hexadiene, 2,5-dimethyl-2,4-hexadiene, 1,3-octadiene, 1,3-cyclopentadiene, 1,3-cyclohexadiene, 1-methoxy-1,3-butadiene, 2-methoxy-1,3-butadiene, 1-ethoxy-1,3-butadiene, 2-ethoxy-1,3-butadiene, 2-nitro-1,3-butadiene, chloroprene, 1-chloro-1,3-butadiene, 1-bromo-1,3-butadiene, 2-bromo-1,3-butadiene, fulvene, tropone, ocimene, phellandrene, myrcene, farnesene, cembrene, sorbic acid, sorbic acid ester, sorbate, and abietic acid; conjugated trienes having a conjugated structure including three carbon-carbon double bonds, such as 1,3,5-hexatriene, 2,4,6-octatriene-1-carboxylic acid, eleostearic acid, tung oil, and cholecalciferol; conjugated polyenes having a conjugated structure including four or more carbon-carbon double bonds, such as cyclooctatetraene, 2,4,6,8-decatetraene-1-carboxylic acid, retinol, and retinoic acid; and the like.

Specific examples of the aromatic compound which may be used as the polymerization inhibitor include p-benzoquinone, hydroquinone, t-butylhydroquinone, hydroquinone monomethyl ether, 2-phenyl-1-propene, 2-phenyl-1-butene, 2,4-diphenyl-4-methyl-1-pentene, 3,5-diphenyl-5-methyl-2-heptene, 2,4,6-triphenyl-4,6-dimethyl-1-heptene, 3,5,7-triphenyl-5-ethyl-7-methyl-2-nonene, 1,3-diphenyl-1-butene, 2,4-diphenyl-4-methyl-2-pentene, 3,5-diphenyl-5-methyl-3-heptene, 1,3,5-triphenyl-1-hexene, 2,4,6-triphenyl-4,6-dimethyl-2-heptene, 3,5,7-triphenyl-5-ethyl-7-methyl-3-nonene, 1-phenyl-1,3-butadiene, 1,4-diphenyl-1,3-butadiene, and the like.

The copolymerization reaction between the vinyl ester monomer and the N-vinylamide monomer may be stopped by cooling of a reaction liquid; however, in light of obtaining the polyvinyl alcohol resin of the present invention, both cooling of the reaction liquid and the addition of the polymerization inhibitor are preferably performed.

As described above, from the obtained solution containing the vinyl ester copolymer, remaining unreacted monomers, especially the N-vinylamide monomer and the like, are preferably removed as much as possible. The remaining monomers are preferably removed under reduced pressure. A solution temperature during the removal operation is, for example, preferably 20° C. or more and 60° C. or less, and preferably 25° C. or more and 55° C. or less. The lower limit of this solution temperature may be 35° C. Furthermore, the upper limit of this solution temperature may be 45° C. or 35° C.

The modified PVA can be obtained in such a manner that the vinyl ester copolymer obtained is subjected to, for example, saponification in an alcohol solvent and then to drying.

Examples of a solvent which may be used in the saponification reaction include methanol, methyl acetate, dimethyl sulfoxide, diethyl sulfoxide, dimethyl formamide, and the like. Of these solvents, methanol is preferred.

As a catalyst in the saponification reaction of the vinyl ester copolymer, an alkaline substance is typically used. Examples of the alkaline substance include: hydroxides of alkali metals, such as potassium hydroxide and sodium hydroxide; alkali metal alkoxides such as sodium methoxide; and the like. The lower limit of an amount of the catalyst used is, in terms of a molar ratio of the vinyl ester copolymer to the vinyl ester unit, preferably 0.002 and more preferably 0.004. On the other hand, the upper limit of the amount of the catalyst used is, in terms of the molar ratio of the vinyl ester copolymer to the vinyl ester unit, preferably 0.2 and more preferably 0.1. The saponification catalyst may be entirely added in the initial stage of the saponification reaction, or it may be possible to add a part of the saponification catalyst in the initial stage of the saponification reaction and then to add the rest in the middle of the saponification reaction.

A reaction temperature at which the saponification reaction is performed is not particularly limited and is preferably 5° C. or more and 80° C. or less. Furthermore, a period of time of the saponification reaction is preferably 5 min or more and 10 hrs or less. The saponification reaction may be performed by either a batch method or a continuous method. After the completion of the saponification reaction, as needed, the remaining catalyst may be neutralized. Examples of a neutralizer which may be used include: organic acids such as acetic acid and lactic acid; ester compounds such as methyl acetate; and the like.

After the saponification, as needed, a step of cleaning the modified PVA may be provided. As a cleaning solution, it is possible to use a solution which contains a lower alcohol such as methanol or the like as a principal component and further contains water and/or ester identical to that generated in the saponification step, such as methyl acetate or the like. After the cleaning, as needed, drying may be performed; thus, the modified PVA can be obtained. The product obtained through these steps may be a PVA resin containing the modified PVA as a principal component. That is to say, the above-described method for producing a modified PVA may be a method for producing a PVA resin.

Other Component(s), Physical Properties, etc.

The PVA resin may contain other component(s) aside from the modified PVA. Example of the other component(s) include an N-vinylamide compound, methanol, a polymerization inhibitor, water, and the like.

In the production of the polyvinyl alcohol resin of the present invention, it is preferred to inhibit, during a process after the completion of the polymerization, the generation of a polymer containing a high content of the N-vinylamide monomer. In this respect, by using a polymerization inhibitor after the completion of the polymerization to reduce the ratio (N1/N2) between the numbers of particles, it is possible to adjust it within the range specified by the present invention. Thus, in the case in which the PVA resin contains the polymerization inhibitor, the ratio (N1/N2) between the numbers of particles is small, and the filterability in a state of an aqueous solution is higher. Examples of the polymerization inhibitor which may be contained in the PVA resin include those listed in the description of the production of the modified PVA. A content of the polymerization inhibitor in the PVA resin may be, for example, 0.0001% by mass or more and 1% by mass or less, or may be 0.001% by mass or more and 0.1% by mass or less.

The PVA resin preferably has a biodegradation rate of 60% or more, more preferably 70% or more, and still more preferably 80% or more. The PVA resin having such favorable biodegradability is particularly advantageous as a material for forming a water-soluble film used for unit packaging or the like. The upper limit of the biodegradation rate may be 100% or may be 99%, 95%, or 92%.

Specifically, the biodegradation rate is defined as a value measured by the following procedure.

To 800 mL of deionized water, 10 mL of a solution A (a solution obtained by dissolving 8.5 g of potassium dihydrogen phosphate, 21.75 g of dipotassium hydrogen phosphate, 33.4 g of disodium hydrogen phosphate dihydrate, and 0.5 g of ammonium chloride in deionized water and then adjusting the fluid volume to 1 L), 1 mL of a solution B (a solution obtained by dissolving 27.5 g of calcium chloride in deionized water and then adjusting the fluid volume to 1 L), 1 mL of a solution C (a solution obtained by dissolving 22.5 g of magnesium sulfate heptahydrate in deionized water and then adjusting the fluid volume to 1 L), and 1 mL of a solution D (a solution obtained by dissolving 0.25 g of iron (III) chloride hexahydrate in deionized water and then adjusting the fluid volume to 1 L) are added in this order. Furthermore, an aqueous solution of the PVA resin is added such that the concentration of DOC is 15 mg/L, activated sludge collected from a sewage plant is further added such that the solid content concentration is 30 mg/L, and the fluid volume is adjusted to 1 L. Into a 1,100 mL glass bottle equipped with a magnetic stirrer, 600 mL of this solution is poured, a sleeve is attached to the glass bottle neck, and approximately 0.5 g of sodium hydroxide is put into the glass bottle as a carbon dioxide absorbent. Furthermore, Oxitop (manufactured by Central Kagaku Corp.) is attached to an upper portion of the glass bottle neck, storage is performed at 22° C. for 28 days while stirring, and the oxygen consumption (oxygen consumption (PVA)) in the glass bottle is measured from the amount of decrease in pressure in the bottle. A glass bottle is separately prepared in the same manner as above except that the PVA resin is not added, storage is similarly performed at 22° C. for 28 days while stirring, and the oxygen consumption (oxygen consumption (blank)) is measured. The biodegradation rate of the PVA resin is calculated in accordance with the following equation.

$$Biodegradation rate ( \% ) = 100 \times ( oxygen consumption ( PVA ) ) - ( blank ) ) / ThOD$$

It is to be noted that ThOD represents a theoretical oxygen demand of the modified PVA.

When a cast film obtained from the PVA resin and having an average thickness of 50 μm is subjected to moisture conditioning at 20° C. and 65% RH for 1 week and then to an aqueous dissolution test at 5° C., a period of time of the dissolution is preferably 5 sec or more and 3,000 sec or less. The upper limit of this period of time of the dissolution is more preferably 1,000 sec, still more preferably 400 sec, and even more preferably 100 sec. In the case in which the period of time of the dissolution falls within the above range, a water-soluble film having particularly favorable cold-water solubility can be obtained.

Specifically, the period of time of the dissolution is defined as a value measured by the following procedure.

Into 96 g of deionized water, 4 g of the PVA resin is put and dissolved therein at 95° C. over 2 hrs. The obtained aqueous solution is poured into a form and dried at room temperature to obtain a cast film having an average thickness of 50 μm. The obtained cast film is cut in a size of 3.8 cm×3.5 cm and subjected to moisture conditioning at 20° C. and 65% RH for 1 week. The cast film is inserted into a slide mount (a form having an internal size of a frame of 3.5 cm×2.3 cm), which is then immersed in water (320 mL) at 5° C. being stirred at 300 rpm, and a period of time from the immersion to the completion of the dissolution of the cast film is measured. It is to be noted that the “completion of the dissolution” refers to a state in which the cast film can no longer be visually perceived and the obtained aqueous solution is transparent.

The lower limit of a tensile elongation at break (elongation at break) of the cast film obtained from the PVA resin and having an average thickness of 50 μm is preferably 120%, more preferably 150%, and still more preferably 180%. On the other hand, the upper limit of this tensile elongation at break is not particularly limited and may be, for example, 400% or 300%. Furthermore, the lower limit of a Young's modulus of the cast film is preferably 10 N/mm² and more preferably 15 N/mm². On the other hand, the upper limit of this Young's modulus is not particularly limited and is, for example, 50 N/mm².

Specifically, the tensile elongation at break and the Young's modulus are defined as values measured by the following procedure.

The PVA resin is dissolved in deionized water at 95° C. over 2 hrs to have a concentration of 4%. The obtained aqueous solution is used and dried at 20° C. and 65% RH to form a cast film having an average thickness of 50 μm. The obtained cast film is cut in a size of 1 cm×10 cm wide at 20° C. and 65% RH, and a tensile test is performed with a distance between chucks being 50 mm and a tensile speed being 100 mm/min. A Young's modulus at a film elongation of 10 to 20% and an elongation at film break (elongation at break) are calculated.

A mode of the PVA resin is not particularly limited, and examples thereof include powder, chips, lumps, and the like. Furthermore, the mode may be a film such as a water-soluble film described later or the like, or another molded product.

An application of the PVA resin is not particularly limited, and it can be used for, besides the water-soluble film described later, a variety of applications such as an adhesive, stabilizers for emulsion polymerization and suspension polymerization, a paper processing agent, a fiber processing agent, a binder for an inorganic substance, and the like. Of these applications, the PVA resin is particularly suitable as a material for forming the water-soluble film.

### Water-Soluble Film

The water-soluble film according to one embodiment of the present invention contains the above-described PVA resin according to one embodiment of the present invention. Since containing the PVA resin according to one embodiment of the present invention, the water-soluble film has favorable cold-water solubility, mechanical strength, and biodegradability. Furthermore, the water-soluble film can be produced using, as a raw material, an aqueous solution of the PVA resin having superior filterability and is thus superior in productivity. Therefore, the water-soluble film can be suitably used as packaging materials for a variety of chemicals such as a laundry detergent, a bleach, an agrochemical, and the like. Above all, the water-soluble film can be particularly suitably used as a packaging material for unit packaging.

It is to be noted that the water-soluble film may be produced using an aqueous solution of the PVA resin which has been subjected to filtration or may be produced using an aqueous solution of the PVA resin which has not been subjected to filtration. Furthermore, the water-soluble film may be the one produced by another process without using the aqueous solution of the PVA resin, as long as the PVA resin according to one embodiment of the present invention is contained.

The lower limit of a content of the PVA resin according to one embodiment of the present invention in the water-soluble film is preferably 30% by mass, more preferably 50% by mass, still more preferably 70% by mass, and may be 80% by mass or 90% by mass. On the other hand, the upper limit of the content of the PVA resin may be 100% by mass or may be 99% by mass, 95% by mass, 90% by mass, or 80% by mass.

Furthermore, the lower limit of a content of the modified PVA in the water-soluble film is preferably 30% by mass, more preferably 50% by mass, still more preferably 70% by mass, and may be 80% by mass or 90% by mass. On the other hand, the upper limit of the content of the modified PVA may be 100% by mass or may be 99% by mass, 95% by mass, 90% by mass, or 80% by mass.

The water-soluble film may contain, besides the PVA resin, an additive and/or a processing aid and may contain, for example, an appropriate amount of a plasticizer, a plasticizer compatibilizing agent, a surfactant, a lubricant, a release agent, a filler, a cross-linking agent, an antiblocking agent, an antioxidant, an adhesion reducing agent, an antifoaming agent, nanoparticles such as layered silicate-type nanoclay or the like (e.g., sodium montmorillonite, etc.), a bleach (e.g., sodium metabisulfite, sodium sulfite, etc.), an aversive agent such as a bittering agent or the like (e.g. denatonium benzoate, denatonium saccharide, denatonium chloride, sucrose octaacetate, quinine, or a flavonoid such as quercetin, naringenin, etc.), a stimulant (e.g. capsaicin, piperine, allyl isothiocyanate, resiniferatoxin, etc.), a saccharide, and/or another additive in accordance with the purpose.

The water-soluble film may contain 5 to 50% by mass, preferably 5 to 40% by mass, and more preferably 10 to 40% by mass of a plasticizer. As the plasticizer, one or two or more selected from sorbitol, glycerin, diglycerin, propylene glycol, dipropylene glycol, ethylene glycol, diethylene glycol, triethylene glycol, polyethylene glycol having a molecular weight of 400 or less, 2-methyl-1,3-propanediol, ethanolamine, trimethylolpropane, polyether polyol, isomalto, maltitol, xylitol, erythritol, adonitol, dulcitol, pentaerythritol, mannitol, sugar alcohol, and the like may be contained. The plasticizer may be bio-based, and examples of a bio-based plasticizer include, but not limited to, glycerin, sorbitol, and the like. In general, a water-soluble film is required to have strength and toughness to withstand use in hot and humid areas and cold areas, and especially needs impact resistance at low temperatures. In the case in which the water-soluble film contains the plasticizer, the impact resistance at low temperatures can be improved, the glass transition point of the water-soluble film can be lowered, and the cold-water solubility can be improved.

The water-soluble film may contain a surfactant. The surfactant is used to improve the dispersibility of a solution of the PVA resin during formation of a film. As the surfactant, any of non-ionic, cationic, anionic, and amphoteric surfactants may be used. Examples of a suitable surfactant include, but not limited to, propylene glycol, diethylene glycol, monoethanolamine, an ethylene oxide adduct of polypropylene glycol, an ethylene oxide adduct of an alcohol, an ethylene oxide adduct of alkylphenol, tertiary acetylene glycol, alkanolamide (non-ionic), an ethylene oxide adduct of an amine, a quaternary ammonium salt, an ethylene oxide adduct of a quaternized amine (cationic), a fatty acid alkali metal salt having 8 to 24 carbon atoms, alkylated sulfonate, alkyl-polyethoxylated sulfonate, alkylbenzene sulfonate (anionic), amine oxide, N-alkylated betaine, sulfobetaine (amphoteric ion), and the like. Furthermore, examples of other suitable surfactants include dialkyl sulfosuccinate, lactylated fatty acid ester of glycerin or propylene glycol, lactylated ester of a fatty acid, sodium alkylsulfonate, polysorbate 20, polysorbate 60, polysorbate 65, polysorbate 80, alkylated polyethylene glycol, lecithin, acetylated fatty acid ester of glycerin or propylene glycol, sodium laurylsulfonate, acetylated ester of a fatty acid, myristyl dimethyl amine oxide, trimethyl tallow alkylammonium chloride, a quaternary ammonium compound, salts thereof, and combinations of any of these. In a preferred embodiment, examples of the surfactant include polyoxyethylenated polypropylene glycol, an ethylene oxide adduct of an alcohol, an ethylene oxide adduct of alkylphenol, tertiary acetylene glycol, alkanolamide, an ethylene oxide adduct of an amine, a quaternary ammonium salt, an ethylene oxide adduct of a quaternized amine, amine oxide, N-alkylbetaine, sulfobetaine, and combinations thereof. A content of the surfactant is not particularly limited, may be 0.1 to 8.0% by mass, is preferably 1.0 to 7.0% by mass, more preferably 3.0 to 7.0% by mass, and still more preferably 5.0 to 7.0% by mass, or may be 0.1 to 2.5% by mass. When the content of the surfactant falls within the above range, a film can be further prevented from getting a hole during its formation by a solvent casting process, and a sticky or oily texture of a surface of the obtained film can be further inhibited.

Examples of a suitable lubricant and a suitable release agent which may be contained in the water-soluble film include, but not limited to, a fatty acid or a fatty acid salt, an aliphatic alcohol, aliphatic ester, an aliphatic amine, an aliphatic amine acetate, an aliphatic amide, and the like; of these, a fatty acid, a fatty acid salt, an aliphatic amine acetate, and the like are suitable. In a preferred embodiment of the present invention, a suitable content of the lubricant and/or the release agent in the water-soluble film may be 0.01 to 1.5% by mass and is preferably 0.1 to 1.0% by mass.

An antifoaming agent used in the water-soluble film is not particularly limited, and examples thereof include: hydrophobic silica such as silicone dioxide, siloxane, and silicone ether; fumed silica microparticles; products with the registered trademark “Foam Blast,” namely, “Foam Blast 327,” “Foam Blast UVD,” “Foam Blast 163,” “Foam Blast 269,” “Foam Blast 338,” “Foam Blast 290,” “Foam Blast 332,” “Foam Blast 349,” “Foam Blast 550,” and “Foam Blast 339,” available from Emerald Performance Materials; and the like. In a preferred embodiment of the present invention, a content of the antifoaming agent with respect to 100 parts by mass of the PVA resin or the modified PVA may be 0.01 to 0.5 parts by mass, for example, 0.05 to 0.1 parts by mass, 0.04 to 0.1 parts by mass, 0.03 to 0.1 parts by mass, 0.02 to 0.1 parts by mass, or the like.

The water-soluble film may contain an antioxidant, for example, as a chloride scavenger. A preferred antioxidant (chloride scavenger) may be a sulfite compound, a bisulfite compound, a thiosulfite compound, a thiosulfate compound, an iodide compound, a nitrite compound, a carbamate compound, an ascorbate compound, or a combination thereof. Furthermore, in a preferred embodiment, propyl gallate, a citric acid, sodium metabisulfite (SMBS), a carbamate compound, an ascorbate, or a combination thereof is suitably used as the antioxidant. The amount of the antioxidant added is not particularly limited, is preferably 0.25 to 1.5 parts by mass with respect to 100 parts by mass of the PVA resin or the modified PVA, and may be, for example, 0.25 to 1.5 parts by mass, 0.3 to 1.5 parts by mass, 0.35 to 1.5 parts by mass, 0.4 to 1.5 parts by mass, 0.45 to 1.5 parts by mass, 0.5 to 1.5 parts by mass, 0.75 to 1.5 parts by mass, 1.0 to 1.5 parts by mass, 1.25 to 1.5 parts by mass, or the like.

The water-soluble film may contain a filler, an extender, a filling agent, an antiblocking agent, an adhesion reducing agent, and/or a combination thereof. The filler is not particularly limited, and examples thereof include a starch, a modified starch, cross-linked polyvinylpyrrolidone, cross-linked cellulose, crystallized cellulose, silica, a metal oxide, calcium carbonate, talc, mica, a metallic stearate such as magnesium stearate, and the like. In a preferred embodiment of the present invention, contents of the filler, the extender, the filling agent, the antiblocking agent, and the adhesion reducing agent in the water-soluble film may each be independently 1 to 6% by mass, preferably 1 to 4% by mass, and more preferably 2 to 4% by mass.

Examples of the saccharide include a monosaccharide such as glucose, an oligosaccharide, a polysaccharide, a chain sugar alcohol, and the like. Examples of the polysaccharide include starch, cellulose, chitin, chitosan, hemicellulose, carboxymethylcellulose, methylcellulose, hydroxymethylcellulose, pectin, pullulan, agar, alginic acid, carrageenan, dextrin, trehalose, and the like. Examples of the chain sugar alcohol include: tetritols having 4 carbon atoms, such as threitol and erythritol; pentitols having 5 carbon atoms, such as arabitol and xylitol; hexitols having 6 carbon atoms, such as glycitol, mannitol, and sorbitol; and the like. One type or two or more types of saccharides may be used.

In the case in which the water-soluble film contains the saccharide, the lower limit of a content of the saccharide with respect to 100 parts by mass of the PVA resin or the modified PVA is preferably 1 part by mass, more preferably 2 parts by mass, and still more preferably 3 parts by mass. On the other hand, the upper limit of the content of the saccharide is preferably 100 parts by mass and may be 50 parts by mass or 30 parts by mass. When the content of the saccharide is greater than or equal to the lower limit, the cold-water solubility of the water-soluble film can be improved. On the other hand, when the content of the saccharide is less than or equal to the upper limit, the impact resistance at low temperatures of the water-soluble film can be improved.

As needed, the water-soluble film may appropriately further contain other additive(s) such as a colorant, a fragrance, an extender, an ultraviolet absorber, and the like. Furthermore, the water-soluble film may contain a PVA which is different in type from the above-described modified PVA, or a water-soluble polymer such as a polyacrylamide, a polyacrylic acid, or a salt thereof. Moreover, the water-soluble film may contain a metal salt such as: an alkali metal salt such as sodium acetate; or an alkaline earth metal salt such as magnesium acetate.

The lower limit of an average thickness of the water-soluble film is preferably 10 μm, more preferably 20 μm, and still more preferably 30 μm. The upper limit of the average thickness of the water-soluble film is preferably 200 μm, more preferably 150 μm, and still more preferably 120 μm. When the average thickness of the water-soluble film is greater than or equal to the lower limit, the mechanical strength of the water-soluble film can be improved. On the other hand, when the average thickness of the water-soluble film is less than or equal to the upper limit, the cold-water solubility can be improved, and furthermore, the water-soluble film can be produced at low cost.

To improve the blocking resistance of the water-soluble film, as needed, a surface of the water-soluble film may be roll-matted, an antiblocking powder such as silica, starch, or the like may be applied to the water-soluble film, or embossing may be performed. The surface of the water-soluble film can be roll-matted in such a manner that minute roughness is formed on a roll which at the time of film formation, comes into contact with the water-soluble film before drying. The embossing can be performed in such a manner that, typically after the film is formed, the film is nipped between an embossing roll and a rubber roll while applying heat and/or pressure.

### Method for Producing Water-Soluble Film

A method for producing the water-soluble film is not particularly limited, and the water-soluble film can be produced by a known process such as a casting process (solvent casting process), a calender process, a blow molding process, an extrusion process, a blow extrusion process, a melt extrusion process, or the like. For example, the method for producing a water-soluble film includes: a step of preparing an aqueous solution containing the PVA resin according to one embodiment of the present invention; and a step of forming a film by using the aqueous solution. The method for producing a water-soluble film may further include, before the step of forming, a step of filtering the aqueous solution with a filter.

In the step of preparing the aqueous solution, the PVA resin and, as desired, other component(s) are dissolved in water. It is to be noted that the aqueous solution may contain another solvent aside from the water. A concentration of the PVA resin or the modified PVA in the aqueous solution may be, for example, 1% by mass or more and 20% by mass or less, or may be 3% by mass or more and 12% by mass or less. This aqueous solution may be referred to as a film-forming stock solution or the like in the production of the water-soluble film.

After the preparation of the aqueous solution in which the PVA resin is dissolved and before the film formation, as needed, the aqueous solution may be filtered using a filter. For example, in the case in which dirt, dust, foreign matters, and/or the like are/is present in the solution, the solution may be filtered to remove them. As the filter used in the filtration, a conventionally known filter may be used. A pore size of the filter is not particularly limited and may be, for example, 0.5 μm or more and 2 μm or less. A material of the filter is not particularly limited and may be a synthesized resin, e.g., a fluorine resin such as polytetrafluoroethylene (PTFE) or polyvinylidene fluoride (PVDF). A film may be formed using the aqueous solution which has not been subjected to filtration.

In the step of forming, the obtained solution is put on a flat and smooth casting surface by application or the like. After the solvent evaporates, a dry matter is peeled from the casting surface. After the peeling, as needed, drying in an oven or the like is performed; thus, a water-soluble film is obtained.

### Extruded Product

An extruded product according to one embodiment of the present invention is an extruded product obtained by extruding the PVA resin, the extruded product having a film shape or a filament shape.

### Filament

A filament according to one embodiment of the present invention is a filament containing the PVA resin.

### Non-Woven Fabric

A non-woven fabric according to one embodiment of the present invention includes the filament.

### Container

A container according to one embodiment of the present invention is a container including the water-soluble film as a packaging material. The water-soluble film can be used in a container including it as a packaging material; a mode of the container obtained in such a manner is not particularly limited, and examples thereof include, of the modes of pouches disclosed in paragraphs to of Japanese Unexamined Patent Application, Publication (Translation of PCT Application) No. 2021-523257, those in which the water-soluble film of the present invention is used at least in part.

The container is preferably configured to be charged with at least one chemical selected from the group consisting of an agrochemical, an oxidant, and a detergent, and the chemical may be encapsulated in the container. The container may be a container for at least one chemical selected from the group consisting of an agrochemical, an oxidant, and a detergent. The chemical to be charged or encapsulated in the container is not particularly limited, and examples thereof include conventionally known agrochemicals, oxidants, detergents, and the like. Examples of the agrochemical include, but not limited to, agrochemicals and the like disclosed in paragraph of Japanese Unexamined Patent Application, Publication (Translation of PCT Application) No. 2021-526563. Examples of the oxidant include, but not limited to, hypochlorites, halogenated isocyanurates such as sodium dichloroisocyanurate, trichloroisocyanuric acids, chlorates, chlorites, perchlorates, bromates, perbromates, halogenated hydantoins, perborates, periodates, persulfates, permanganates, chromates, bichromates, nitrates, nitrites, peroxides, ketone peroxides, peroxyacids, inorganic acids, and combinations thereof. Examples of the detergent include, but not limited to, components and the like disclosed in paragraphs to of Japanese Unexamined Patent Application, Publication (Translation of PCT Application) No. 2021-523257.

### Aqueous Solution

An aqueous solution according to one embodiment of the present invention contains the PVA resin according to one embodiment of the present invention.

In the aqueous solution according to one embodiment of the present invention, a content of the PVA resin is preferably 0.1 ppm or more and 50 ppm or less. An aqueous solution containing the PVA resin at such a content tends to have particularly favorable biodegradability.

A temperature of the aqueous solution is not particularly limited and is preferably 20° C. or more and 25° C. or less. An aqueous solution adjusted to have such a temperature also tends to have particularly favorable biodegradability.

The aqueous solution may be, for example, the one in which the water-soluble film according to one embodiment of the present invention is dissolved. The aqueous solution may contain component(s) other than the PVA resin.

The aqueous solution preferably further contains at least one of a magnesium ion or a calcium ion, and more preferably contains both a magnesium ion and a calcium ion. In the case in which the aqueous solution contains these ions, the biodegradability tends to become particularly favorable. A total content of the magnesium ion and the calcium ion in the aqueous solution is preferably 10 ppm or more and 400 ppm or less, and may be 10 ppm or more and 100 ppm or less. These ions may be originally contained in the PVA resin or may be originally contained in a component other than the PVA resin.

In an aqueous solution according to another embodiment of the present invention, the content of the PVA resin is preferably 3% by mass or more and 12% by mass or less. An aqueous solution containing the PVA resin at such a content can be suitably used as a film-forming stock solution for a water-soluble film. As needed, the aqueous solution may contain, for example, each component of the water-soluble film aside from the PVA resin.

### EXAMPLES

Hereinafter, the present invention will be more specifically described by way of Examples, and the present invention is not limited to the Examples.

### Example 1: Production of PVA Resin

Into a 5 L reactor equipped with a stirring blade, a reflux condenser, a nitrogen inlet tube, and a thermometer, 2,040 g of vinyl acetate, 905 g of methanol, and 58.9 g of a 50% N-vinyl-2-pyrrolidone (NVP) solution in methanol were charged, and bubbling with a nitrogen gas was performed for 30 min for degassing. The reactor was started to be heated, and when the internal temperature reached 60° C., 1.5 g of 2,2′-azobis(isobutyronitrile) was added to start polymerization. The polymerization was performed while the 50% N-vinyl-2-pyrrolidone solution in methanol was sequentially added such that its molar ratio to a vinyl acetate monomer was constant, and cooling was performed 5 hrs later. The solid content concentration at this point in time was 34%. Next, 10 g of a 10% t-butylhydroquinone solution in methanol was added as a polymerization inhibitor to stop the reaction. Next, while methanol was occasionally added at 30° C. under reduced pressure, unreacted monomers were removed to obtain a vinyl acetate copolymer solution in methanol (concentration: 33%).

Next, to the vinyl acetate copolymer solution in methanol which was adjusted to have a concentration of 25% by addition of methanol, a NaOH solution in methanol (concentration: 10%) having an alkali molar ratio (number of moles of NaOH/number of moles of a vinyl acetate monomer unit) of 0.03 was added to perform saponification. The obtained gel was pulverized in a pulverizer and left to stand for 1 hr to proceed the saponification, and then, 500 g of methyl acetate was added to neutralize remaining alkalis. Separation by filtration was performed to obtain a while solid, 2,000 g of methanol was added thereto, and the resulting mixture was left to stand for 3 hrs at room temperature and then cleaned. After the cleaning operation was repeated three times, centrifugal deliquoring was performed to obtain a while solid, which was then left to stand in a drier at 65° C. for 2 days to obtain a PVA resin containing a modified PVA (PVA-1) as a principal component.

The average degree of polymerization (viscosity-average degree of polymerization) and the degree of saponification of the PVA-1 were measured in accordance with JIS-K6726-1994. Furthermore, by proton NMR of the vinyl acetate copolymer, the content of the N-vinylamide unit in the vinyl acetate copolymer (i.e., the content of the N-vinylamide unit in the PVA-1: modification rate) was determined. The results are shown in Table 1.

### Measurement of N1 and N2, Calculation of Total Volume of Particles

By the above-described procedure, the number (N1) of 1-μm-size particles and the number (N2) of 2-μm-size particles contained in 1 mL of a 2% by mass aqueous solution of the obtained PVA resin were determined, and the ratio (N1/N2) therebetween was calculated. Furthermore, by the above-described procedure, the total volume of the 1-μm-size particles and the 2-μm-size particles contained in 1 mL of the 2% by mass aqueous solution of the obtained PVA resin was calculated. The results are shown in Table 2.

### Measurement of Biodegradation Rate

The biodegradation rate of the obtained PVA resin was measured by the above-described procedure. It is to be noted that the solution subjected to the measurement had a calcium concentration of 9 ppm and a magnesium concentration of 2 ppm. In the case in which the biodegradation rate was 60% or more, the biodegradability was determined to be favorable. The measured biodegradation rate is shown in Table 3.

### Aqueous Dissolution Test: Evaluation of Cold-Water Solubility

By the above-described procedure, a cast film obtained from the obtained PVA resin and having an average thickness of 50 μm was subjected to moisture conditioning at 20° C. and 65% RH for 1 week and then to an aqueous dissolution test at 5° C., and a period of time of the dissolution was measured. Based on the period of time of the dissolution, the results were evaluated in accordance with the following criteria. In the case of A to D, the cold-water solubility was determined to be favorable. The results are shown in Table 3.
A: 5 sec or more and 100 sec or less
B: greater than 100 sec and 400 sec or less
C: greater than 400 sec and 1,000 sec or less
D: greater than 1,000 sec and 3,000 sec or less
E: greater than 3,000 sec

### Measurement of Mechanical Strength (Young's Modulus and Elongation at Break)

By the above-described procedure, the Young's modulus and the elongation at break of the cast film obtained from the obtained PVA resin and having an average thickness of 50 μm were measured. In the case in which the Young's modulus was 15 N/mm² or more or the elongation at break was 150% or more, the mechanical strength was determined to be favorable. The results are shown in Table 3.

### Filtration Test: Evaluation of Filterability

Deionized water and the obtained PVA resin were added into a 500 mL separable flask equipped with a stirring blade, and while stirring, the resulting mixture was processed at 95° C. for 2 hrs to prepare 400 mL of a 2% aqueous solution. This solution was conditioned to have a temperature of 20° C., poured into a suction filtration device (filtration area: 9.6 cm²) equipped with a PTFE membrane filter having a pore size of 1 μm (“T100A,” manufactured by Advantech), and subjected to suction filtration using an aspirator while the degree of vacuum during suction was maintained at 0.020 to 0.022 MPa. A period of time (t50) from the filtration start to the completion of the filtration of 50 mL of the solution, a period of time (t100) from the filtration start to the completion of the filtration of 100 mL of the solution, a period of time (t150) from the filtration start to the completion of the filtration of 150 mL of the solution, and a period of time (t200) from the filtration start to the completion of the filtration of 200 mL of the solution were measured. A ratio (T1/T2) of a period of time (T1=t100−t50) from the completion of the filtration of 50 mL of the solution to the completion of the filtration of 100 mL of the solution, to a period of time (T2=t200-t150) from the completion of the filtration of 150 mL of the solution to the completion of the filtration of 200 mL of the solution was determined. As the ratio (T1/T2) is closer to 1, the filterability is superior. In the case in which the ratio (T1/T2) was 0.70 or more, the filterability was determined to be superior, and in the case of 0.80 or more, the filterability was determined to be particularly superior. The results are shown in Table 3.

### Examples 2 to 22, Comparative Examples 1 to 5

PVA resins containing modified PVAs (PVA-2 to PVA-27) as their respective principal components were obtained in the same manner as in Example 1, except that the production conditions were adjusted such that the modified PVAs obtained could each have the average degree of polymerization, the degree of saponification, and the modification rate shown in Table 1 and that the type of N-vinylamide, the addition or not of a polymerization inhibitor at the end of the polymerization, and the temperature at the time of removing the unreacted monomers after the polymerization were as shown in Table 1. It is to be noted that in Table 1, “NVC” represents N-vinylcaprolactam. The modified PVAs and PVA resins obtained were subjected to each measurement and evaluation in the same manner as in Example 1. The results are shown in Tables 1 to 3.

TABLE 1

| | PVA resin | | | | | | |
|---|---|---|---|---|---|---|---|
| | | | | | | | temperature |
| | | | | | | | at time of |
| | | average | degree of | modification | | addition or not of | removing |
| | modified | degree of | saponification | rate | | polymerization | monomers |
| | PVA | polymerization | (mol %) | (mol %) | N-vinylamide | inhibiter | (° C.) |
| Example 1 | PVA-1 | 1,500 | 88.1 | 1.7 | NVP | added | 30 |
| Example 2 | PVA-2 | 1,500 | 82.4 | 1.8 | NVP | added | 30 |
| Example 3 | PVA-3 | 1,500 | 80.0 | 1.7 | NVP | added | 30 |
| Example 4 | PVA-4 | 1,500 | 92.3 | 1.7 | NVP | added | 30 |
| Example 5 | PVA-5 | 1,500 | 96.9 | 1.8 | NVP | added | 30 |
| Example 6 | PVA-6 | 1,500 | 99.1 | 1.7 | NVP | added | 30 |
| Example 7 | PVA-7 | 1,500 | 87.7 | 1.1 | NVP | added | 30 |
| Example 8 | PVA-8 | 1,500 | 87.9 | 3.0 | NVP | added | 30 |
| Example 9 | PVA-9 | 1,500 | 88.0 | 3.5 | NVP | added | 30 |
| Example 10 | PVA-10 | 1,500 | 87.7 | 4.6 | NVP | added | 30 |
| Example 11 | PVA-11 | 1,500 | 98.9 | 4.7 | NVP | added | 30 |
| Example 12 | PVA-12 | 700 | 87.2 | 1.7 | NVP | added | 30 |
| Example 13 | PVA-13 | 1,000 | 88.0 | 1.8 | NVP | added | 30 |
| Example 14 | PVA-14 | 2,000 | 87.5 | 1.7 | NVP | added | 30 |
| Example 15 | PVA-15 | 2,400 | 87.6 | 1.6 | NVP | added | 30 |
| Example 16 | PVA-16 | 4,500 | 87.9 | 1.8 | NVP | added | 30 |
| Example 17 | PVA-17 | 1,500 | 88.1 | 1.8 | NVC | added | 30 |
| Example 18 | PVA-18 | 1,500 | 82.3 | 1.7 | NVC | added | 30 |
| Example 19 | PVA-19 | 1,500 | 98.4 | 1.7 | NVC | added | 30 |
| Example 20 | PVA-20 | 1,500 | 88.2 | 3.5 | NVC | added | 30 |
| Example 21 | PVA-21 | 1,500 | 88.0 | 1.7 | NVP | added | 50 |
| Example 22 | PVA-22 | 1,500 | 87.8 | 1.8 | NVP | added | 40 |
| Comparative Example 1 | PVA-23 | 1,500 | 87.8 | 1.9 | NVP | not added | 30 |
| Comparative Example 2 | PVA-24 | 1,500 | 82.2 | 1.7 | NVP | not added | 30 |
| Comparative Example 3 | PVA-25 | 1,500 | 96.8 | 1.7 | NVP | not added | 30 |
| Comparative Example 4 | PVA-26 | 1,500 | 88.1 | 3.5 | NVP | not added | 30 |
| Comparative Example 5 | PVA-27 | 1,500 | 88.1 | 4.7 | NVP | not added | 30 |

TABLE 2

| | PVA resin | | | | |
|---|---|---|---|---|---|
| | | | | | total |
| | modified | ratio | | | volume |
| | PVA | (N1/N2) | N1 | N2 | (μm³) |
| Example 1 | PVA-1 | 3.2 | 230 | 73 | 620 |
| Example 2 | PVA-2 | 3.0 | 189 | 63 | 527 |
| Example 3 | PVA-3 | 2.7 | 172 | 63 | 511 |
| Example 4 | PVA-4 | 4.3 | 435 | 101 | 965 |
| Example 5 | PVA-5 | 4.4 | 782 | 178 | 1,713 |
| Example 6 | PVA-6 | 4.8 | 1,821 | 376 | 3,769 |
| Example 7 | PVA-7 | 2.6 | 189 | 74 | 589 |
| Example 8 | PVA-8 | 3.9 | 374 | 96 | 880 |
| Example 9 | PVA-9 | 4.8 | 489 | 101 | 1,013 |
| Example 10 | PVA-10 | 7.5 | 814 | 109 | 1,352 |
| Example 11 | PVA-11 | 21.8 | 4,632 | 212 | 5,386 |
| Example 12 | PVA-12 | 3.0 | 198 | 65 | 547 |
| Example 13 | PVA-13 | 3.1 | 231 | 74 | 627 |
| Example 14 | PVA-14 | 3.0 | 252 | 83 | 697 |
| Example 15 | PVA-15 | 3.2 | 319 | 101 | 859 |
| Example 16 | PVA-16 | 2.9 | 472 | 163 | 1,348 |
| Example 17 | PVA-17 | 3.5 | 342 | 98 | 863 |
| Example 18 | PVA-18 | 3.9 | 251 | 65 | 594 |
| Example 19 | PVA-19 | 4.6 | 569 | 124 | 1,213 |
| Example 20 | PVA-20 | 11.9 | 2,431 | 205 | 3,356 |
| Example 21 | PVA-21 | 0.3 | 151 | 454 | 2,701 |
| Example 22 | PVA-22 | 0.6 | 121 | 203 | 1,256 |
| Comparative | PVA-23 | 67.6 | 3,921 | 58 | 3,873 |
| Example 1 | | | | | |
| Comparative | PVA-24 | 69.4 | 3,264 | 47 | 3,217 |
| Example 2 | | | | | |
| Comparative | PVA-25 | 78.8 | 5,672 | 72 | 5,536 |
| Example 3 | | | | | |
| Comparative | PVA-26 | 122.9 | 6,636 | 54 | 6,306 |
| Example 4 | | | | | |
| Comparative | PVA-27 | 208.4 | 7,921 | 38 | 7,378 |
| Example 5 | | | | | |

TABLE 3

| | | Evaluation results | | | | |
|---|---|---|---|---|---|---|
| | PVA resin | biodegradation | cold-water | Young's | elongation | |
| | modified | rate | solubility | modulus | at break | filterability |
| | PVA | (%) | (5° C.) | (N/mm²) | (%) | (ratio (T1/T2)) |
| Example 1 | PVA-1 | 85 | B | 23.1 | 189 | 0.85 |
| Example 2 | PVA-2 | 81 | A | 17.7 | 220 | 0.87 |
| Example 3 | PVA-3 | 78 | A | 14.4 | 232 | 0.87 |
| Example 4 | PVA-4 | 85 | B | 25.1 | 187 | 0.85 |
| Example 5 | PVA-5 | 87 | C | 28.6 | 184 | 0.84 |
| Example 6 | PVA-6 | 87 | D | 30.4 | 189 | 0.80 |
| Example 7 | PVA-7 | 88 | B | 24.0 | 193 | 0.90 |
| Example 8 | PVA-8 | 82 | A | 21.6 | 210 | 0.83 |
| Example 9 | PVA-9 | 77 | A | 21.8 | 226 | 0.83 |
| Example 10 | PVA-10 | 65 | A | 20.3 | 241 | 0.81 |
| Example 11 | PVA-11 | 67 | C | 28.6 | 205 | 0.78 |
| Example 12 | PVA-12 | 89 | B | 24.2 | 138 | 0.89 |
| Example 13 | PVA-13 | 88 | B | 23.6 | 168 | 0.90 |
| Example 14 | PVA-14 | 82 | B | 24.1 | 216 | 0.83 |
| Example 15 | PVA-15 | 80 | B | 23.9 | 213 | 0.81 |
| Example 16 | PVA-16 | 76 | C | 24.5 | 245 | 0.80 |
| Example 17 | PVA-17 | 76 | C | 24.3 | 193 | 0.83 |
| Example 18 | PVA-18 | 71 | B | 18.3 | 217 | 0.84 |
| Example 19 | PVA-19 | 78 | D | 31.2 | 196 | 0.82 |
| Example 20 | PVA-20 | 65 | C | 22.0 | 219 | 0.78 |
| Example 21 | PVA-21 | 84 | B | 22.8 | 207 | 0.87 |
| Example 22 | PVA-22 | 85 | B | 23.3 | 197 | 0.87 |
| Comparative Example 1 | PVA-23 | 86 | B | 24.1 | 215 | 0.65 |
| Comparative Example 2 | PVA-24 | 83 | A | 18.0 | 239 | 0.68 |
| Comparative Example 3 | PVA-25 | 89 | C | 27.7 | 194 | 0.62 |
| Comparative Example 4 | PVA-26 | 75 | A | 21.9 | 216 | 0.58 |
| Comparative Example 5 | PVA-27 | 65 | A | 22.3 | 209 | 0.59 |

As shown in the results in Tables 1 to 3, each of the PVA resins of Examples 1 to 22 enabled obtaining a water-soluble film having favorable cold-water solubility and mechanical strength, had favorable biodegradability, and was superior in filterability in a state of an aqueous solution. On the other hand, each of the PVA resins of Comparative Examples 1 to 5 had a ratio (N1/N2) of greater than 50 and was inferior in filterability. It is to be noted that each of the PVA resins of Comparative Examples 1 to 5 was obtained without the addition of the polymerization inhibitor at the end of the polymerization, as in Examples disclosed in Patent Document 1. The results indicate that when the polymerization inhibitor was not added at the end of the polymerization, the PVA resin obtained had a ratio (N1/N2) of greater than 50.

### INDUSTRIAL APPLICABILITY

The PVA resin of the present invention can be suitably used as, e.g., a material of a water-soluble film, an extruded product, a filament, a non-woven fabric, and a container.

1. A polyvinyl alcohol resin comprising, as a principal component, a modified polyvinyl alcohol comprising an N-vinylamide unit,
wherein a ratio (N1/N2) of the number (N1) of 1-μm-size particles to the number (N2) of 2-μm-size particles comprised in 1 mL of a 2% by mass aqueous solution of the polyvinyl alcohol resin is 0.1 or more and 50 or less.

2. The polyvinyl alcohol resin according to claim 1, wherein the modified polyvinyl alcohol has a content of the N-vinylamide unit of 0.3 mol % or more and 10 mol % or less, a degree of saponification of 70 mol % or more and 99.9 mol % or less, and an average degree of polymerization of 200 or more and 4,500 or less.

3. The polyvinyl alcohol resin according to claim 1, wherein a total volume of the 1-μm-size particles and the 2-μm-size particles comprised in 1 ml of the 2% by mass aqueous solution of the polyvinyl alcohol resin is 1 μm³ or more and 10,000 μm³ or less.

4. The polyvinyl alcohol resin according to claim 1, having a biodegradation rate of 60% or more.

5. The polyvinyl alcohol resin according to claim 1, wherein when a cast film obtained from the polyvinyl alcohol resin and having an average thickness of 50 μm is subjected to moisture conditioning at 20° C. and 65% RH for 1 week and then to an aqueous dissolution test at 5° C., a period of time of the dissolution is 5 sec or more and 3,000 sec or less.

6. The polyvinyl alcohol resin according to claim 1, further comprising a polymerization inhibitor.

7. A water-soluble film comprising the polyvinyl alcohol resin according to claim 1.

8. The water-soluble film according to claim 7, formed from the polyvinyl alcohol resin in accordance with at least one process selected from the group consisting of a solvent casting process, a calender process, a blow molding process, an extrusion process, and a blow extrusion process.

9. An extruded product obtained by extruding the polyvinyl alcohol resin according to claim 1, the extruded product having a film shape or a filament shape.

10. A filament comprising the polyvinyl alcohol resin according to claim 1.

11. A non-woven fabric comprising the filament according to claim 10.

12. A container comprising the water-soluble film according to claim 7 as a packaging material.

13. The container according to claim 12, configured to be charged with at least one selected from the group consisting of an agrochemical, an oxidant, and a detergent.

14. A method for producing a water-soluble film, the method comprising:
preparing an aqueous solution comprising the polyvinyl alcohol resin according to claim 1; and
forming a film by using the aqueous solution.

15. The method for producing a water-soluble film according to claim 14, the method further comprising:
before the forming,
filtering the aqueous solution with a filter.

16. An aqueous solution comprising the polyvinyl alcohol resin according to claim 1,
wherein a content of the polyvinyl alcohol resin is 0.1 ppm or more and 50 ppm or less.

17. The aqueous solution according to claim 16, having a temperature of 20° C. or more and 25° C. or less.

18. The aqueous solution according to claim 16, further comprising at least one of a magnesium ion or a calcium ion,
wherein a total content of the magnesium ion and the calcium ion is 10 ppm or more and 400 ppm or less.

19. An aqueous solution comprising the polyvinyl alcohol resin according to claim 1,
wherein a content of the polyvinyl alcohol resin is 3% by mass or more and 12% by mass or less.
